(19) United States
(12) Patent Application Publication
(10) Pub. No.: US 2005/0247392 A1
(43) Pub. Date: Nov. 10, 2005

(54) Method and apparatus for producing an insulating glass structure

(76) Inventor: Peter Lisec, Hausmeningen-Amstetten (AT)

Correspondence Address: EDELL, SHAPIRO & FINNAN, LLC, 1901 RESEARCH BOULEVARD, SUITE 400, ROCKVILLE, MD, 20850, US

(21) Appl. No.: 11/181,842

(22) Filed: Jul. 15, 2005

(30) Foreign Application Priority Data
Oct. 28, 2003 (DE) 103 50 312.9

(51) Int. Cl. B29C 65/00

(52) U.S. Cl. 156/109; 156/356

(57) ABSTRACT

A method and apparatus for applying an elastoplastic strip as a spacer in the production of insulating glass panes comprising a supply winder for the strip, several driven strip guide rollers, and a pressing head for the strip which is movable relative to a first glass pane. In contrast to the state of the art, an elastoplastic band is used whose side surfaces are not yet coated with an adhesive. The adhesive is applied only shortly before the application of the strip onto its two side surfaces. For this purpose, mutually opposing nozzles that coat the side surfaces of the strip with an adhesive are arranged between the supply winder and the pressing head.

### CROSS REFERENCE TO RELATED APPLICATIONS

This application is a continuation of PCT/IB2004/002206, filed Jul. 1, 2004, and titled “Process and Device for Producing an Insulating Glass Pane,” which claims priority to German Application No. DE 103 50 312.9, filed on Oct. 28, 2003, and titled “A Process and Device for Producing an Insulating Glass Pane,” the entire contents of each are hereby incorporated by reference.

### FIELD OF THE INVENTION

The invention relates to a method and an apparatus for producing insulating glass structures and, in particular, to a structure comprising at least two glass panes between which an elastoplastic spacer strip is arranged.

### BACKGROUND

An insulating glass structure (e.g., a window unit) comprising two or more glass panes typically uses spacers situated between the panels made of hollow aluminum or steel profiles. For example, U.S. Pat. No. 4,431,691 (Greenlee) discloses a spacer in the form of a strip with a rectangular cross section. This spacer, provided with protective films on two opposing sides (e.g., inner and outer sides), is dispensed by a storage drum or winder and is applied to the glass pane using an apparatus provided with a turning head. This strip-like spacer is formed from butyl caoutchouc, a viscoelastic material (also called an elastoplastic). The material is a strong adhesive, which is desirable for achieving a gas-tight connection between the panes of the insulating glass unit. The viscosity of the material, however, is temperature dependent, which not poses manufacturing disadvantages, but also makes the spacers less resilient with respect to their shape and dimensions. Another example of such a window spacer is the Swiggle Strip® product, manufactured by TrueSeal Technologies, Beachwood, Ohio (www.swiggle.com).

Recently, less temperature-sensitive elastoplastic spacer strips formed from polyurethane or the like have been developed. These polyurethane spacers (which also have a rectangular cross section) are also more resilient with respect to shape and dimension when compare to those formed from butyl-based elastoplastics. These spacers typically comprise (on their outer side) a lamination made of aluminum film and are provided only on the two narrow sides designated for gluing with the glass panes with the thin coating made of an adhesive, which coating is covered with a protective film until the application. U.S. Published Patent Application 2003-0178127 to Lisec discloses a method and apparatus for applying such a strip onto at least the first glass pane of an insulating glass pane consisting of at least two such glass panes, the aforementioned reference being incorporated by reference in its entirety.

However, the adhesive glue applied to the two narrow sides of the strip shows no tightness against the diffusion of water vapor. That is why, after the assembly of the insulating glass pane, the remaining boundary joint needs to be filled with a jointing compound to ensure the mandatory tightness against the diffusion of water vapor. Otherwise, over time, water vapor would penetrate the enclosed inner space of the insulating glass pane, leading to the formation of condensation and rendering the glass pane useless. Suitable jointing compounds are expensive; moreover, they are required in large quantities due to the considerable cross section of the boundary joint.

### OBJECTS AND SUMMARY

An object of the disclosed invention is to provide a cost-effective method for producing insulating glass panes and to provide an apparatus which is especially suitable for performing the method. In contrast with the state-of-the-art, an elastoplastic strip is used whose side surfaces are not coated with an adhesive until shortly before the application of the strip onto the two side surfaces of the superimposed glass panes. This leads to the advantage of allowing the use of an adhesive best suited for a given insulating unit (i.e., an adhesive having the proper composition, application parameters, etc.), which, in turn, ensures that each respective side surface of the strip adheres to its respective glass pane to form a fluid-tight seal, preventing the diffusion of water vapor. As a result, the application of jointing compounds with which the remaining boundary joint is filled is no longer necessary to provide a water-vapor-tight seal. In addition, when jointing compounds are applied, less expensive formulations can be used (than those previously required).

A further advantage is that the inventive, factory-made strip including adhesive coated on its side surfaces makes it possible to omit cover or protective films. In addition to reducing the production cost of the strip, omission of the protective films further eliminates the need to withdraw the films and wind them up for disposal.

In the method according to the invention, the strip is preferably placed (and pressed) onto a glass pane using an automated application station. A butyl-based adhesive is preferably used as the adhesive, since butyl adhesives have a proven track record in coating side surfaces of spacer frames made of hollow metal profiles. The quantity of glue applied to the strip may be regulated using the strip transport speed to provide an adhesive layer with a substantially constant thickness. This can be achieved by keeping the adhesive consumed per unit of time for the application proportional to the strip transport speed, which means that it goes towards zero especially upon standstill of the strip.

In addition, the thickness of the adhesive coating is kept substantially constant irrespective of the transport speed. This is achieved by measuring the actual value of the thickness of the coating and using any deviation from a predetermined set point value as an error signal. Suitable methods for measuring the coating thickness are known.

The object of the invention is further achieved with an apparatus comprising a supply winder for an elastoplastic strip, several motor-driven strip guide rolls, and a pressing head for the strip that is movable relative to a first glass pane. The apparatus further comprises mutually opposing nozzles arranged between the supply winder and the pressing head that coat an adhesive onto the side surfaces of the strip to provide a tight seal effective against the diffusion of water vapor. The coating nozzles can be adapted to control the adhesive throughput depending on the strip transport speed.

At least one first pair of rollers for the lateral guidance of the strip can be arranged before the coating nozzles relating to the direction of transport of the strip. Furthermore, a mechanism that guides the height of the strip within the system can also be provided, positioned before the coating nozzles. The height guidance mechanism may comprise a simple horizontal supporting web, a supporting roll on which the strip rests, or a pair of rollers between which the strip passes.

Additionally, pairs of rollers can be arranged after the coating nozzles to laterally guide the strip. The rollers may be configured to only touch the strip at the edges of its side surfaces to not only prevent any soiling of the rollers by the freshly applied layer of adhesive, but also to avoid damaging the adhesive coating.

In the case of precise dosing, a string of adhesive can be applied to each of the side surfaces of the strip whose cross section is dimensioned in such a way that upon pressing the strip against the first glass pane, or upon pressing the second glass pane against the other side surface of the strip, an even layer of adhesive is formed without the adhesive pouring over the edges of the side surfaces of the strip.

The nozzles of the adhesive coating station may comprise slotted nozzles. In this case, the width of the slot of the coating nozzles can be smaller than the width of the side surfaces of the strip to ensure that excessive application of adhesive is avoided, as well as ensure that the applied coating does not extend beyond the edge of the side surfaces of the strip. Such an application also prevents contact between the adhesive and the lateral guide mechanism comprising pairs of rollers (as mentioned above), thus preventing adhesive from contaminating the rollers and interfering with the operation of the rollers.

A device for measuring the thickness of the coating may be positioned downstream from the coating nozzles, which device regulates the adhesive throughput through the coating nozzles.

The above and still further objects, features and advantages of the present invention will become apparent upon consideration of the following detailed description of specific embodiments thereof, particularly when taken in conjunction with the accompanying drawings wherein like reference numerals in the various figures are utilized to designate like components.

### BRIEF DESCRIPTION OF THE DRAWINGS

FIG. 1 illustrates a simplified side view of an apparatus for applying a spacer strip according to an embodiment of the invention.

FIG. 2 illustrates a cross-sectional view of the coating station of the apparatus of FIG. 1, showing a spacer strip as it travels between the coating nozzles.

FIG. 3 illustrates a cross-sectional view of the lateral guidance station, showing a pair of rollers orienting the strip.

### DETAILED DESCRIPTION

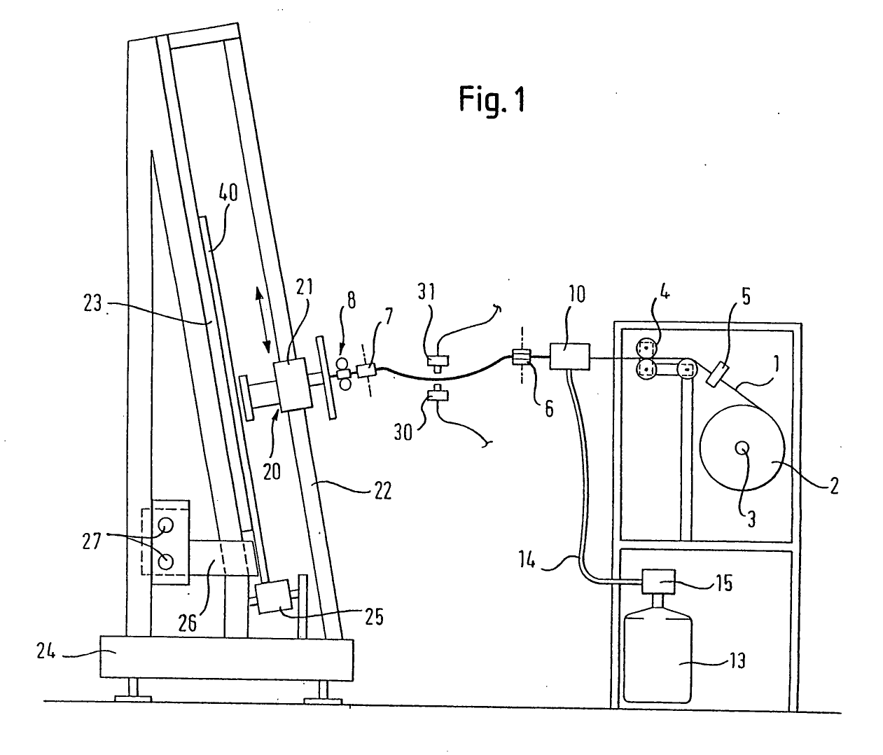

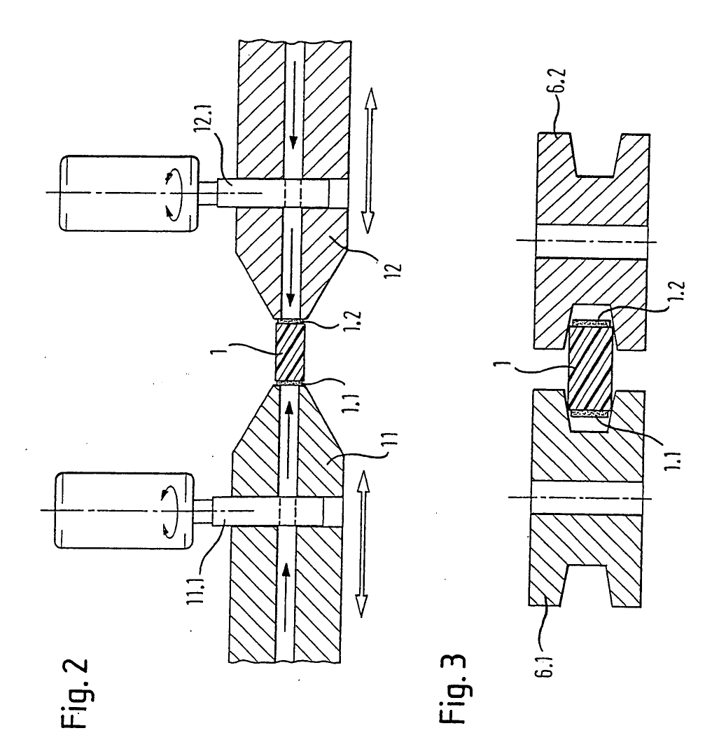

FIG. 1 shows an apparatus for applying a spacer strip to a window pane according to an embodiment of the invention. As shown, an elastoplastic strip 1 may be drawn from a supply spool or winder 2 situated on a motor-driven shaft 3. The size and shape of the strip 1 is not limited. By way of example, the strip 1 may comprise a rectangular cross section (seen best in FIG. 2). The composition of the strip 1 is not limited, so long as it is suitable for use as a spacer for an insulating unit. By way of example, the strip may comprise an elastoplastic (an elastic-perfectly plastic) material. The strip 1 travels downstream from the supply winder 2, through guide rollers 4 and a distance measuring device 5, and to a coating station 10. The coating station 10 is configured to coat the strip 1 with an adhesive. The coating station 10 may be connected, via a conduit 14 with a pump 15, to a container 13 containing an adhesive (e.g., a butyl adhesive). At the coating station 10, the adhesive layer is applied to the side surfaces of the strip.

A lateral guidance station 6 may be positioned downstream from the coating station 10. The station 6 may comprise a pair of rollers (not shown, seen in FIG. 3) configured to laterally guide the coated strip 1. This may be followed by a sagging station, i.e., a section in which the strip 1 is allowed to sag without support. The sagging is kept between an (upper) minimum value and a (lower) maximum value by a lower sensor 30 and an upper sensor 31. The sensors 31, 32 may be connected via the indicated signal leads to a machine control unit (not shown) that controls the winder 2 and the roller drives in response to measurements taken by the sensors 30, 31. As a result, the machine control unit maintains the integrity of the strip while ensuring that the strip travels through a second pair of rollers 7 and 8 and enters an application or pressing head 20 without any longitudinal tensions (i.e., the strip 1 is neither squashed nor pulled apart).

The application head 20 may be positioned on a carriage 21 configured to move in a generally vertical direction (indicated by a double arrow) along a pillar 22. The pillar 22 may be slightly inclined towards the vertical and positioned parallel to a conventional supporting wall 23 (e.g., an air cushion supporting wall resting on a machine frame 24). A glass pane 40 rests on the supporting wall 23, with the lower edge of the pane resting on a roller conveyor 25. The roller conveyor 25 is operable to reversibly transport the glass pane 40. In addition, a conventional vacuum conveyor 26 displaceable along horizontal posts 27 may be used. The application head 20 can be twisted about an axis perpendicular to the pillar 22. The application head 20 presses the strip 1 against the glass pane 40 such that the strip is applied around the pane 40 proximate its edge. The strip 1 is placed close to the edge of the glass pane using conventional, controlled application/head displacement techniques.

FIG. 2 illustrates a cross-sectional view of the coating station 10 of FIG. 1. As shown, the coating station 10 includes nozzles 11 and 12 operable to apply the adhesive (e.g., butyl adhesive) onto the side surfaces of strip 1. The throughput of the adhesive through each of the nozzles 11, 12 can be controlled or regulated using motorized slides 11.1 and 12.1. Specifically, the nozzles 11, 12 may be displaceable according to the double arrows for adjusting the distance of their orifices to strips of different width. The servomotors drive the slides 11.1, 12.1 such that the side surfaces of the strip 1 are each coated with an adhesive layer 1.1 and 1.2 having a substantially constant thickness. The constant thickness of each adhesive layer 1.1, 1.2 may be obtained by maintaining the adhesive consumed per unit of time for the application proportional to the strip transport speed. Preferably, however, the constant thickness of each adhesive layer 1.1, 1.2 is independent of the momentary speed of strip 1. To achieve this, the actual value of the thickness of the coating is measured and the deviation from a predetermined set point value is used as an error signal for keeping constant the coating thickness. For this purpose, the drive motors of slides 11.1, 12.1, as well as the downstream thickness measuring devices may be connected with the machine control unit (not shown, discussed above).

FIG. 3 is a cross-sectional view of the lateral guidance station 6 of FIG. 1 As shown the lateral guide station 6, positioned downstream from the coating station, includes a pair of rollers 6.1 and 6.2 provided with a running surface having a substantially wedge-shaped profile. The running surface is operable to laterally guide the strip 1 so that the rollers 6.1, 6.2 only touch the strip 1 at the edges of the side surfaces of the strip. The rollers 6.1, 6.2 can be provided with a free-running configuration, or can be situated on motorized shafts (not shown) configured to keep the circumferential speed of the rollers 6.1, 6.2 synchronous and in agreement with the momentary or momentarily required strip running speed. In addition, other rollers in the apparatus (e.g., the second pair of rollers 7 and 8) may be similarly shaped and configured.

In operation, the elastoplastic strip 1 is withdrawn from the supply winder 2 and travels to the coating station 10, where two opposing surfaces of the strip are coated with an adhesive 1.1, 1.2. The coating station 10 includes the coating nozzles 11, 12 comprising slots having a width smaller than that of the width of the strip 1, thus ensuring the coating is kept within the boundaries of the strip (even when the strip is pressed onto a pane of glass). The thickness of the adhesive coating 1.1, 1.2, while not limited, may be regulated by a controller associated with the nozzles. One side of the adhesive-coated strip 1 is then applied to a first glass pane to effectively form a spacer. The strip 1 may be placed onto the first glass pane by using an automated application station that presses the strip 1 against the first glass pane. Afterwards, a second glass pane is applied to (and pressed against) the first glass pane such that it contacts the other side of the adhesive-coated strip, creating an insulating glass structure (namely, a window unit). The adhesive, and thus the resulting spacer strip, is capable of forming a fluid tight seal, i.e., a seal that is tight against the diffusion of water vapor.

While the invention has been described in detail and with reference to specific embodiments thereof, it will be apparent to one skilled in the art that various changes and modifications can be made therein without departing from the spirit and scope thereof. Accordingly, it is intended that the present invention covers the modifications and variations of this invention provided they come within the scope of the appended claims and their equivalents.

1. A method for producing an insulating glass structure comprising:
withdrawing an elastoplastic strip from a supply winder, the strip including a first side surface and a second side surface;
coating the first and second side surfaces with an adhesive capable of forming a seal tight against the diffusion of water vapor;
pressing the strip first side surface against a first glass pane to form a spacer; and
applying and pressing a second glass pane to the first glass pane such that it contacts the strip second side surface.

2. A method according to claim 1, wherein the adhesive capable of forming a seal tight against the diffusion of water vapor comprises a butyl adhesive.

3. A method according to claim 1, wherein an automated station applies the strip to the first glass pane.

4. A method according to claim 1, wherein the quantity of adhesive applied to the strip is regulated depending on the transport speed of the strip.

5. A method according to claim 1, wherein a thickness of the adhesive coating is kept substantially constant irrespective of the transport speed of the strip.

6. A method according to claim 5, wherein an actual value of the thickness of the coating is measured and a deviation from a predetermined set point value is used as an error signal to keep the coating thickness constant.

7. An apparatus for applying an elastoplastic strip as a spacer in the production of an insulating glass structure, the apparatus, comprising:
a strip supply winder configured to supply a strip having opposing side surfaces;
a plurality of rollers configured to guide the strip through the apparatus;
a strip application head movable relative to a first glass pane; and
opposing nozzles operable to coat the opposing side surfaces with an adhesive, the nozzles being positioned between the supply winder and the application head.

8. An apparatus according to claim 7, wherein the coating nozzles are associated with a controller operable to regulate a thickness of the adhesive coating depending on the transport speed of the strip.

9. An apparatus according to claim 7, wherein the plurality of rollers includes a pair of rollers adapted to laterally guide the strip, the rollers being positioned upstream with respect to the coating nozzles.

10. An apparatus according to claim 7 further comprising a strip height guidance mechanism positioned upstream with respect to the coating nozzles.

11. An apparatus according to claim 7, wherein the plurality of rollers includes rollers positioned downstream with respect to the coating nozzles, wherein the rollers only contact only the edges of the side surfaces of the strip and do not contact adhesive coated onto the strip.

12. An apparatus according to claim 7, wherein the coating nozzles each comprise at least one slot.

13. An apparatus according to claim 12, wherein the width of the slot is smaller than the width of the opposing strip side surfaces.

14. An apparatus according to 7 further comprising a device operable to measure the thickness of the adhesive coating and regulate the adhesive throughput through the coating nozzles, the device positioned downstream with respect to the coating nozzles.
